(19) United States
(12) Patent Application Publication
(10) Pub. No.: US 2003/0000479 A1
(43) Pub. Date: Jan. 2, 2003

(54) Automated system for counting livestock

(76) Inventor: Jerry L. Starr, Mooreland, OK (US)

Correspondence Address: JERRY L. STARR, ROUTE 1 BOX 129, MOORELAND, OK, 73852, US

(21) Appl. No.: 09/895,575

(22) Filed: Jul. 2, 2001

(51) Int. Cl. A01K 29/00

(52) U.S. Cl. 119/174

(57) ABSTRACT

This invention is an automated livestock counting system utilizing a computer-controlled transponder interrogating RFID eartags to display to determine and display a highwater mark of initial occurrences each 24 hours. As counting livestock or other entities is it's only function, a uniquely written program is the core of the invention.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO A MICROFICHE APPENDIX

Not applicable

### BACKGROUND OF INVENTION

The present invention relates to a system for counting livestock or other entities. It is aimed at such ease of use as to be considered automatic in it's counting function as well as being affordable due to it's simplistic design and narrow focus.

In the conventional art, different means (eartags, collars, implants) are used to identify animals in different ways (RF signals to drive transponders, special gloves with portable electronic devices). The most common system is RFID eartags with unique addresses or codes which are energized and interrogated by a transponder to identify animals. Once identified, most systems do additional complex functions such as stressing an animal, feeding an animal, weighing an animal, or monitoring an animals bodily function, performance, or activity.

The problem is none of these systems and their applications perform only a counting, or headcount, function. They either just identify some animals presence or they do more complex functions of which counting is sometimes a part. Usually the monitoring is occurring in non-natural, non-dynamic settings such as barns, feed lots, and feed bunker systems.

### BRIEF SUMMARY OF THE INVENTION

The invention provides an automated system designed specifically to count livestock, especially cattle. The most basic and repetitive function of the common rancher or herdsman is counting the herd to assure availability of all animals. This invention does this as simply and inexpensively as possible while providing unattended use in a dynamic, natural setting.

### BRIEF DESCRIPTION OF THE DRAWING

FIG. 1 shows a flowchart which represents the logic flow to be programmed into the computer controller to count initial occurrences of unique RFID eartags each 24 hours, thus providing a headcount of a herd.

### DETAILED DESCRIPTION OF THE INVENTION

This invention in an improvement over existing animal monitoring systems because of it's objective. It defines a narrow scope of function and uses existing technologies, for the most part, to achieve it's objective with the improvement being an unique software program. The objective is to dynamically count in a natural setting a herd of livestock in an automated fashion and display the current ‘highwater mark’ of said herd count on an LED or similar display device. In keeping with this invention's singular function it is designed to be a system that is simple to initiate, relatively affordable, and unattended in it's operation.

The components needed to implement this invention are a controlling processor with adequate memory for the expected number of animals or entities to be counted, an LED or other display suitable for outdoor viewing, a DC solar power supply system, a transponder, an uniquely addressed RFID eartag responder on each animal to be counted in a herd, a clock, the uniquely written user program running under the processor's central program (operating system), and a processor-controlled interface to the clock and the LED display and the transponder. These are all items that are readily available except the uniquely written user program, and that have been previously utilized in other inventions (such as U.S. Pat. No. 5,901,660 to Stein, or U.S. Pat. No. 5,711,246 to Yano, et. al.). My improvement to this general animal monitoring configuration would be the uniquely written user program which is designed specifically to achieve the logic of detecting initial occurrences of unique RFID eartags each 24 hours and relating this to a current headcount which is maintained in memory as well as on the LED readout. This headcount represents the highwater mark of animals the have been dynamically encountered up to that point in time.

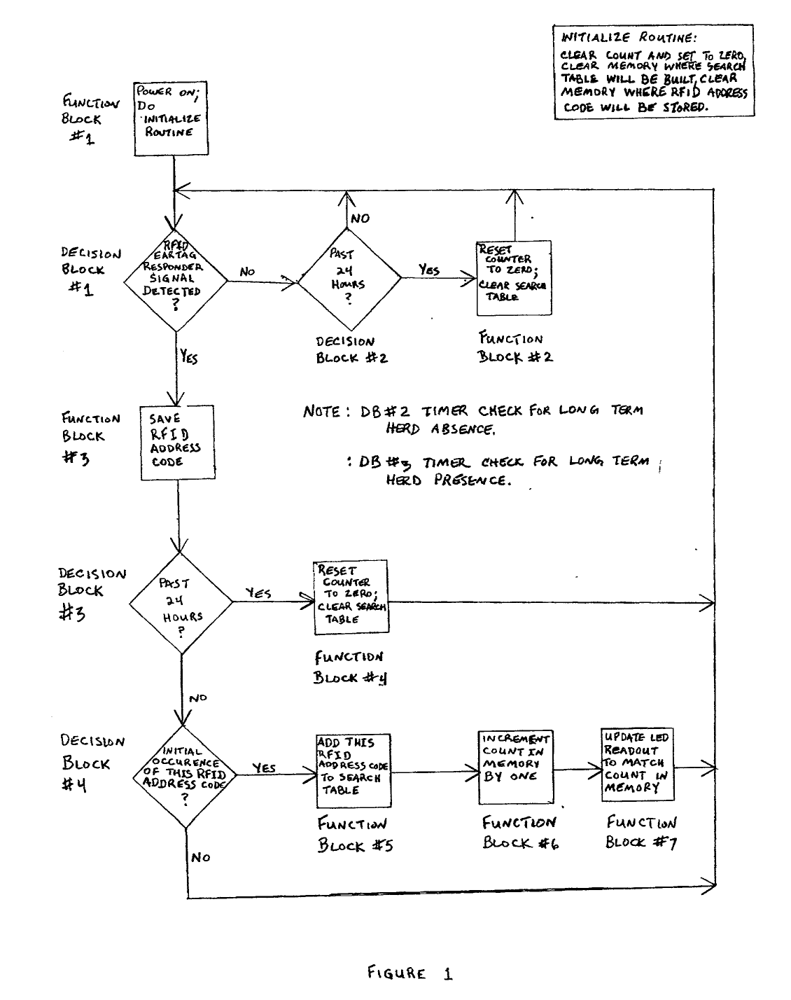

Referring to the flowchart in FIG. 1, this is achieved by the following program logic:

When the unit is powered on the initialization routine (function block #1) is executed to initially clear the headcount and set it to zero, clear the memory where the search table will be built, and clear the memory where RFID address codes will be stored. The program then proceeds on (decision block #1).

If no livestock are in the area of the invention (hereafter called the counter), the program logic stays in a standby loop (decision block #1, no branch; decision block #2; and function block #2). In the standby loop, if no RFID eartag responder signal is detected, (decision block #1, no branch), the clock counter is checked to see if 24 hours has elapsed. If it hasn't (decision block #2, no branch) the program again checks for an RFID eartag responder signal (decision block #1). If 24 hours has elapsed, the program resets the headcount to zero and clears all RFID address code entries from the search table (function block #2) and again check for an RFID eartag responder signal (decision block #1).

The standby loop is exited when a monitored animal wearing an RFID eartag responder is in close enough proximity for the transponder to illicit a signal from the RFID eartag responder (decision block #1, yes branch). The RFID address code is temporarily saved by placing it in memory (function block #3) and the program then checks to see if 24 hours has elapsed. If it has (decision block #3, yes branch) the program resets the counter to zero and clears all RFID address code entries from the search table (function block #4). The program again checks for an RFID eartag responder signal (decision block #1) to start this new 24 hour period. If 24 hours hasn't elapsed (decision block #3, no branch), the program proceeds on to check for an initial occurrence of this temporarily stored RFID address code (decision block #4). If this in not the first occurrence of this temporarily stored RFID address code for this 24 hour period due to finding a match during the table search of previously stored address codes (decision block #4, no branch), the program again checks for an RFID eartag responder signal (decision block #1). If this is the initial occurrence of this temporarily stored RFID address code for this 24 hour period due to not finding a match during the table search of previously stored codes (decision block #4, yes branch), the program then adds this temporarily stored RFID address code to the search table in memory (function block #5), increments the headcount in memory by one (function block #6), updates the LED display to match the count in memory (function block #7) and again checks for an RFID eartag responder signal (decision block #1).

### PREFERRED EMBODIMENT

The most common and redundant job of a rancher or herdsman is counting their herd to derive a headcount so they can determine livestock availability. It's a task that's done once a day, every day. It takes a large amount of the rancher's or herdsman's time and thus an automated solution is proposed. The counter is designed to be as simple to use and as affordable to purchase as possible in an effort to make this invention a basic and viable tool of any rancher or herdsman with a medium-sized herd on up to the largest. Usually an automated herd counting tool is not cost effective for the rancher or herdsman with a small operation.

Once the herd size to be counted is properly matched with a counting unit with enough memory to accommodate that quantity, the counter would be strategically placed and powered on. It is envisioned the counter would be placed near the watering area as animals must water at least daily However, any place assured of full herd presence or passage in a natural setting will work. Each animal in the herd that is to be counted must have a uniquely addressed RFID eartag responder.

Once the counter is powered on and goes through an initialization proecess, it will begin counting initial occurrences of RFID eartags as they are naturally encountered throughout the 24 hour counting period. One will note that the time-of-day the unit is powered on determines the start of the 24 hour counting period. As animals come and go in their daily routine they are counted as they come in close enough proximity to the counter. They are counted once each 24 hours. Instead of driving into a pasture or field and interactively counting a herd, a rancher or herdsman could drive by the location of the counter, such as a water tank, and check the current ‘high water mark’ of the counter's display. If the number displayed is less than the known headcount the rancher or herdsman could either do a manual headcount or check the counter again later in the day. Large scale operations would probably not incur the overhead of a manual headcount unless the counter showed a low count for 2 or more days. Most users would optimize the chance of getting a full headcount on the counter by checking it after a herd's known time to go to water. This describes it's intended implementation and use, although the inventor envisions other counting uses beyond livestock. Anywhere unique identification devices are currently worn or could be worn, the counter would provide it's function. Other embodiments of this counting system, such as transmission of a headcount from a remotely operation system, are envisioned and included.

1. I claim an improvement to existing animal monitoring systems to achieve the singular function of automatically counting animals wearing uniquely addressed eartags, this improvement consisting of a uniquely designed computer program which is uniquely implemented on existing animal monitoring system equipment.
